(19) United States
(12) Patent Application Publication
(10) Pub. No.: US 2008/0053879 A1
(43) Pub. Date: Mar. 6, 2008

(54) Filter pressure indicator

(76) Inventor: David N. Harris, Sonora, CA (US)

Correspondence Address: HENNEMAN & ASSOCIATES, PLC, 714 W. MICHIGAN AVENUE, THREE RIVERS, MI, 49093, US

(21) Appl. No.: 11/514,397

(22) Filed: Aug. 30, 2006

(51) Int. Cl. B01D 35/14; B29C 67/20

(52) U.S. Cl. 210/90; 264/46.6

(57) ABSTRACT

A fluid filter having a fluid pressure sensor integral with a canister enclosing a filter medium, such that the fluid filter can be removed and replaced as a unit and further such that a new fluid pressure sensor is provided each time the fluid filter is replaced. The fluid filter can be readily adapted to many different fluid systems. In some embodiments, the fluid filter has two housing sections fastened together to enclose a filter medium. In some embodiments, the sensor includes an indicator that is easily visible outside of the housing. In some embodiments the indicator is responsive to a predetermined fluid pressure within the fluid filter.

### BACKGROUND OF THE INVENTION

1. Field of the Invention

This invention relates generally to fluid filters, and more particularly to indicators associated with fluid filters for alerting a user when the filter has become or is becoming clogged or otherwise inoperative.

2. Description of the Background Art

Fluid filters, particularly oil filters, are used in a great variety of applications, including in engines to increase their operational lifetimes by reducing wear on engine components caused by minute particulates suspended in the engine oil. During engine operation particulate matter is removed from the circulating engine oil by the oil filter. As the filter medium becomes increasingly filled with engine particles it clogs, and the filter's cleaning effectiveness is thereby substantially reduced because less particulate matter can be trapped by the filter medium. In addition, if the filter becomes excessively clogged, in order to avoid the catastrophic consequences resulting from a failure of the oil to continue to circulate through the engine, a bypass valve is often provided that will open, thereby diverting the engine oil around the filter medium. Therefore, to minimize the occurrences of filter clogs, the engine oil and filter are generally changed at prescribed intervals as measured by distance traveled, duration of engine operation, or the like. A clogged oil filter is undesirable because more particulate matter will be circulating through the engine, causing unnecessary engine wear, thereby decreasing the useful life of the engine.

Although changing or servicing the oil filter regularly is generally considered to be adequate, there are several factors that can cause oil filters to become prematurely clogged. For example, extremely old or worn engines may have more loose particles floating in the engine than newer engines. Also, oil filters servicing engines that have a pre-existing build up of “sludge” might clog faster than oil filters on new engines. Additionally, operating an engine on an increased duty cycle, or placing an unusual amount of stress on the engine such as by using it for towing, in heavy machinery, or the like, may cause the oil filter to rapidly clog because more particulate matter is produced. Finally, new engines that are still in their “break-in” period can produce more particulate matter than seasoned engines, which can cause the oil filter to become clogged sooner. A clean oil supply is important during break-in to ensure that the engine “wears in” correctly. Despite these factors, engines are often run with clogged oil filters without the operator's knowledge which, if consistently done, will prematurely wear out the engine.

In addition to oil filters, other types of fluid filters also experience clogging that could be easily prevented if the condition of the filter was easily and readily known. For example, a fuel filter becomes clogged over time as it extracts particulate matter from the fuel delivered to an engine. However, many vehicle owners neglect the fuel system of their vehicle, forgetting to change their fuel filter on a regular basis. A clogged fuel filter will typically show its symptoms by diminished engine performance, and in some extreme cases, a fuel-starved engine will stop running altogether. In addition, the undesirable consequences of a potentially clogged fuel filter can occur without much prior warning. Therefore, as with oil filters, it would be beneficial to know when a fuel filter is becoming clogged so as to prevent a poorly performing vehicle.

There have been devices disclosed in the prior art that detect when the pressure differential across the filtering medium is sufficient such that a filter is no longer effectively functioning. Such devices, however, have often been rather complex and, therefore, expensive to produce. Furthermore, there is a problem in that prior art indicator devices that are generally permanently affixed to the engine or other such apparatus and, therefore, may tend to become clogged and/or worn and either unusable or inaccurate over time.

What is needed, therefore, is a fluid filter having a pressure indicator that can be easily incorporated into a common filtering system, is cost effective, accurate, reliable, and that is quickly readable by a servicing party to determine if the filter requires changing.

### SUMMARY

The present invention overcomes the problems associated with the prior art by providing a fluid filter canister that encloses a filter medium wherein the canister has an integral pressure sensor device such that the entire apparatus can be removed and/or replaced as a unit. Thereby problems potentially associated with contamination, clogging and wear of the sensor apparatus are avoided. The invention enables a user to easily see when a fluid filter is no longer permitting proper oil flow by actuating an indicator that is easily visible outside of the housing.

In the following paragraphs, several variations of the present invention will be introduced. These embodiments by no means represents represent an exhaustive list of the many forms that this invention might take.

In one embodiment, the disposable fluid filter includes two housing sections fixed together to enclose a filter medium and includes an indicator that is visible outside of the housing. The indicator is responsive to a predetermined fluid pressure within the fluid filter.

In another embodiment, an indicator is visible from the outside through one of the two housing sections. By way of example, a transparent window may be incorporated into one section of the housing. In a more particular embodiment, the housing section that includes the window, further includes a plurality of hatch marks that show the condition of the filter medium.

Optimally, the indicator passes directly through the housing such that a user can see what condition the filter medium is in by simply looking at the fluid filter. In one variation, the fluid filter includes a partition that prevents fluid from flowing into a compartment of the canister. In a more particular embodiment, the indicator is coupled to the partition, wherein the partition is movably responsive to an increase in fluid pressure. As fluid pressure increases, the partition responds by moving downward, consequently, moving the indicator into an actuated position. In an even more particular embodiment, a spring is disposed to secure the partition into a non actuated position. In yet another particular embodiment, the partition forms a portion of a bypass valve that allows fluid to pass by the filter medium in the case of a clogging condition.

In yet another embodiment, the filter medium is movably disposed within the canister. Further, the filter medium is attached to the partition such that upon an increase in fluid pressure, the filter medium moves along with the partition. In a more particular embodiment, the indicator is fixed to the movable filter. In an even more particular embodiment, the fluid filter further includes a retaining device operative to retain the indicator into an indicated position.

In still another embodiment, a thermally expandable washer is disposed around the indicator shaft such that indicator does not actuate under an initial start-up surge or under cold temperatures that would make the fluid more viscous than normal.

In yet another particular embodiment, the fluid filter includes an alternate indicator which comprises a pressure member that further includes a first surface for fluid pressure to exert force thereon. Further, a shaft that passes through the housing is coupled to the pressure member such that when the pressure member is forced outward, the shaft protrudes outward to indicate a dirty filter. In a more particular embodiment, a boot is formed over a spring that is disposed between a second surface of the pressure member (on the opposite side of the first surface) and the interior wall of the housing. The boot prevents fluid pressure from exerting force on the second surface of the pressure member that would oppose the force exerted on the first surface.

In yet another particular embodiment, the fluid filter includes an optional indicator which includes an expandable chamber that increases in volume in response to an increase in fluid pressure. In a more particular embodiment, the expandable portion includes a corrugated wall that further includes a spring disposed therein.

In another particular embodiment, the fluid filter comprises two housing portions slidably fixed together such that under an increase in fluid pressure from a dirty filter, one of the housing portions slides partially out of the other housing portion. In a more particular embodiment, the housing portions include engaging features that provide means for the housing to expand into different stages according to the fluid pressure. For example, upon an increase in fluid pressure, engaging features of the inner housing section will slide over complementary engaging features of the outer housing section such that engaging features will secure the fluid filter into an actuated position. In an even more particular embodiment, the inner housing portion includes indicia that are only visible when the fluid filter is expanded into an actuated position.

Another embodiment of the invention has an electrical contact associated with a sensor such that a wire can be attached to the sensor apparatus for sending a signal to a remote indicator when the sensor is activated by excessive pressure in the cylinder.

A method for manufacturing a disposable canister is also described. The method includes the steps of providing a filter medium, providing a fluid pressure indicator, providing a canister, and assembling the filter medium, the fluid pressure indicator, and the canister into a disposable canister filter.

### BRIEF DESCRIPTION OF THE DRAWINGS

The present invention is described with reference to the following drawings, wherein like reference numbers denote substantially similar elements:

FIG. 1A is a front elevational view of a disposable oil filter having an oil pressure indicator in an un-actuated position according to one embodiment of the present invention;

FIG. 1B is a front elevational view of a disposable oil filter having an oil pressure indicator in an actuated position according to one embodiment of the present invention;

FIG. 2 is a cross-sectional view of the oil filter of FIG. 1A taken along line A-A;

FIG. 3 is a cross-sectional view of the oil filter of FIG. 1B taken along line A-A, showing the filter in a clogged condition;

FIG. 4 is an exploded view the oil filter shown in FIGS. 2 and 3;

FIG. 5 is an exploded view of one embodiment of an oil pressure indicator incorporated into the oil filter shown in FIGS. 1A and 1B;

FIG. 6 is a top view of the filter medium shown in FIGS. 2-4 according to one embodiment of the present invention;

FIG. 7 is a cross-section of the oil filter of FIG. 1A taken along line A-A according to an alternate embodiment of the present invention;

FIG. 8 is a front view of an oil filter having an oil pressure indicator according to yet another embodiment of the present invention;

FIG. 9A is a cross-section of an oil filter having an oil pressure indicator according to still another embodiment of the present invention;

FIG. 9B is a top view of a channeled washer oil filter of FIG. 9A;

FIG. 10A is a cross-section of a FRAM™ oil filter modified to include an oil pressure indicator according to another embodiment of the present invention in a non-actuated position;

FIG. 10B is a cross-section of the modified FRAM™ oil filter of FIG. 10A where the oil pressure indicator is in an actuated position;

FIG. 11 is a cross-section of an in-line fluid filter having a fluid pressure indicator according to one embodiment of the present invention;

FIG. 12A is a cross-section of a clean in-line fluid filter having a fluid pressure indicator according to an alternate embodiment of the present invention;

FIG. 12B is a cross-section of the in-line fluid filter of FIG. 12A where the fluid pressure indicator is in an actuated position; and

FIG. 13 is a cross sectional view of an alternate pressure indicator apparatus.

### DETAILED DESCRIPTION

The present invention overcomes the problems associated with the prior art, by providing a disposable fluid filter with a visible indicator that indicates when the filter is clogged and no longer filtering the fluid effectively. In the following description, numerous specific details are set forth in order to provide a thorough understanding of the invention. Those skilled in the art will recognize, however, that the invention may be practiced apart from these specific details. In other instances, details of manufacturing practices and components known in the art of making fluid filters have been omitted, so as not to unnecessarily obscure the present invention.

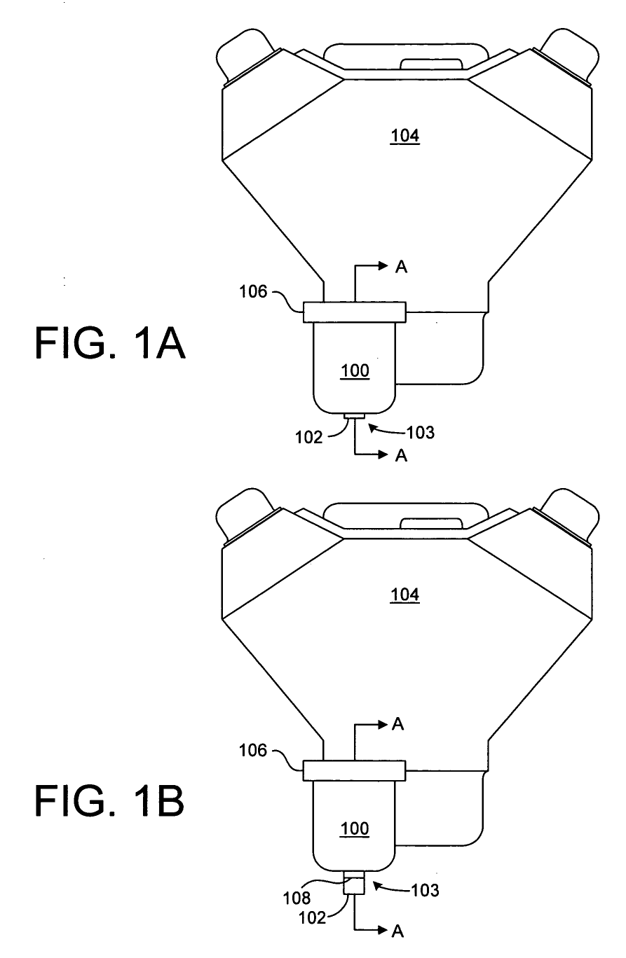

FIG. 1A is a front elevational view of an example of an oil filter 100. The oil filter 100 has an oil pressure indicator 102 that is part of a pressure indicator apparatus 103 according to one embodiment of the present invention. Oil filter 100 is secured (in this example, threaded onto) to a machine 104 (in this example, an automobile type engine) at an engine filter receiver 106 in the manner of conventional filters such as may be replaced by the present inventive oil filter 100. Oil filter 100 removes particulates from the oil circulating through machine 104 and indicates, when protruding, to a servicer of machine 104 that oil filter 100 is clogged as shown by the oil pressure indicator 102.

Oil pressure indicator 102 is externally visible to the servicer of machine 104, and signals when filter 100 is clogged by protruding at various distances from oil filter 100. In FIG. 1A, oil filter 100 is in a non-actuated position, thereby informing the servicer that oil filter 100 is not clogged and is filtering the oil properly.

FIG. 1B is a front view of oil filter 100 showing indicator 102 in an actuated position. As the oil pressure within oil filter 100 builds, indicator 102 protrudes progressively farther from the bottom of oil filter 100. When the pressure within oil filter 100 reaches a predetermined pressure, an indicia 108 is exposed on indicator 102 indicating that oil filter 100 is clogged and is need of replacement. In the present embodiment, indicia 108 is a single line scribed around indicator 102, however indicia 108 might also be represented by a change in color of indicator 102, a notch or groove cut in indicator 102, or any other suitable means for indicating that a predetermined pressure has been reached within oil filter 100.

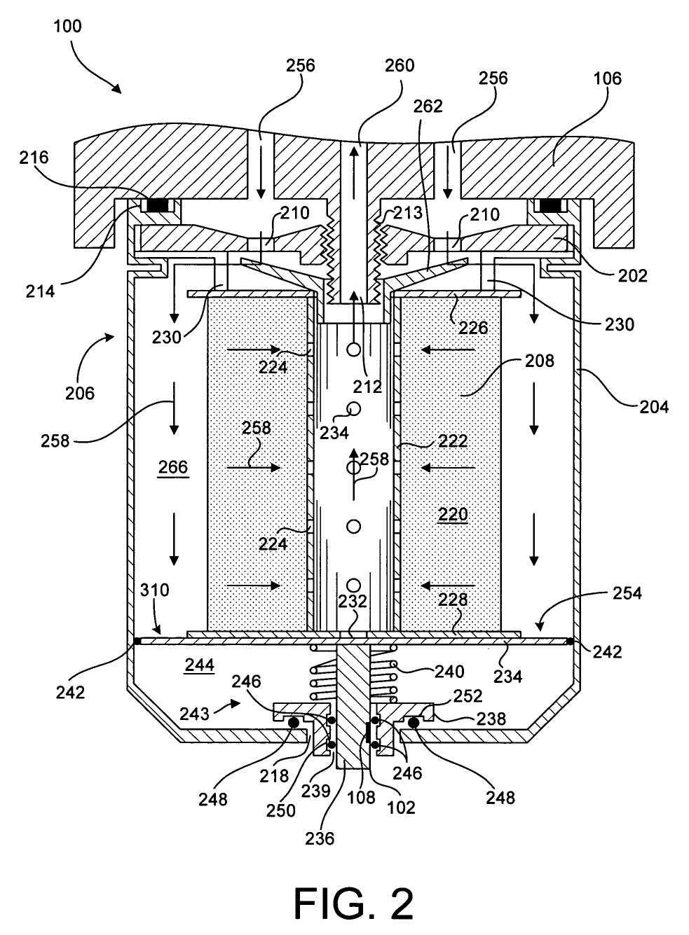

FIG. 2 is a cross-sectional view of oil filter 100 taken along line A-A of FIG. 1. As shown in FIG. 2, oil filter 100 includes a first housing section 202, a second housing section 204 fixed to first housing section 202 to define a filter canister 206, a filter medium 208, and indicator 102. First housing section 202 is a metal (steel, in this present example) disk defining a plurality of oil inlet ports 210 and a threaded filter attachment aperture 212. Oil inlet apertures 210 (typically 8 to 12, two of which are visible in the view of FIG. 2) are disposed annularly around the filter attachment aperture 212. Oil inlet apertures facilitate the flow of oil into filter canister 206. Threaded aperture 212 is formed in the middle of the first housing section 202 and facilitates the attachment of the oil filter 100 to machine 104. In particular, oil filter 100 can be screwed onto the filter receiver 106 such that the threads of aperture 212 engage complementary threads 213 formed in the filter receiver 106.

Second housing section 204 is a cylindrical container stamped from a sheet metal (sheet steel in the example). The diameter of second housing section 204 is slightly larger than the diameter of first housing section 202 such that first housing section 202 can be positioned within second housing section 204, and second housing section 204 can be crimped around first housing section 202. The crimped portion of second housing section 204 forms an o-ring seat 214 around the circumference of the top of first housing section 202. 0-ring seat 214 retains an o-ring 216 that creates a seal between oil filter 100 and filter receiver 106 once oil filter 100 is tightly secured to filter receiver 106. The second housing section 104 includes an indicator aperture 218, through which a portion of indicator 102 is disposed.

Filter medium 208 is generally a standard filtering medium used in conventional disposable oil filters. Filter medium 208 includes a hollow, cylindrical, fiber based filtering material 220 disposed around a central filter cylinder 222, which defines a plurality of ports 224. Filter medium 208 also includes an upper cap 226 and a lower cap 228 that bound the upper and lower limits, respectively, of filtering medium 208 and provide added structure thereto. As is known in the art, the filter medium 208 is optionally corrugated or folded on its outer surface in order to present more surface area to the oil to be filtered.

In addition to these standard features, filter medium 208 also includes a plurality of support members 230 (two of which are visible in the view of FIG. 2), which are each fixed to the upper cap 226 (by an adhesive in this example) and crimped in between first housing section 202 and second housing section 204. Support members 230, once crimped between first and second housing sections 202 and 204 prevent filter medium from moving toward the bottom of second housing section 204 as will be described in greater detail below. In addition to support members 230, lower cap 228 defines a bypass aperture 232 that permits unfiltered oil to flow into central filter cylinder 222 when filtering medium 206 becomes clogged, as will be discussed in more detail hereinafter.

Indicator 102 includes a partition 234, a shaft 236, an indicator plug 238, and a biasing member 240. Indicator plug 238 has a plug aperture 239 through which the shaft 236 is slidably affixed. Partition 234 is a circular plate that travels vertically in the lower portion of second housing section 204. Partition 234 includes a pressure seal 242 disposed around the circumference of partition 234 to prevent oil from passing into a chamber 244 below partition 234. In the present embodiment, pressure seal 242 is formed from a resilient rubber ring, however variations might include any other suitable seal such as a stretchable or expandable seal affixed between the inner wall of the second housing portion 204 and partition 234.

Collectively, the partition 234, shaft 236, indicator plug 238, biasing member 240 and pressure seal 242 are assembled into a unit referred to as a bypass apparatus 243.

Shaft 236 is affixed to the bottom of partition 234 and passes through the indicator plug 238 and also through the aperture 218 of second housing portion 204 such that is visible from the outside of oil filter 100 when the partition 234 is moved downward causing a portion of the shaft 236 to protrude from the indicator plug 238. Furthermore, the outside of shaft 236 includes indicia 108 (FIG. 1B) which, as described above, indicates to a servicer of the machine 104 that the filer medium 208 is clogged and oil filter 100 needs to be changed.

Indicator plug 238 centers indicator shaft 236 in aperture 218 and stabilizes partition 234 via shaft 236 such that partition 234 does not deflect when filter 100 is pressurized with oil. Optionally, indicator plug 238 includes a plurality of seals 246 and 248 seated in grooves 250 and 252 respectively, which would prevent oil from leaking out of filter 100 in the case that pressure seal 242 failed and oil leaked into chamber 244. Finally, indicator plug 238 can be retained in aperture 218 in several ways. For example, indicator plug 238 could be glued to second housing section 204, formed as an integral part of second housing section 204, press fit into aperture 218, or could be held in place by pressure exerted against it by the biasing member 240. In this present example, the indicator plug 238 is press fit into aperture 218.

Finally, biasing member 240 provides a biasing force against partition 234 which tends to counteract the force generated on the top of partition 234 by the oil in filter 100. In the present embodiment, biasing member 240 is a spring disposed around indicator shaft 236 and between partition 234 and indicator plug 238. Although in the present embodiment indicator plug 238 provides a stable base for biasing member 240 to press against, if indicator plug 238 were omitted, biasing member 240 could alternately press against second housing section 204 around aperture 218. Biasing member 240 resists the force generated on the upper side of partition 234 by pressurized oil. As the pressure of the oil builds, biasing member 240 compresses, causing indicator shaft 236 to protrude from the bottom of filter 100, thereby indicating that filter medium 208 is clogged. It should be understood that alternate biasing members (e.g., resilient tubes, elastomeric elements, rubber elements, etc. with known compression characteristics) can be substituted for coil spring 240.

The force to be exerted by biasing member 240 against the partition 234 is determined based on several factors. A first factor is the amount of compression (e.g., a distance x) that biasing member 240 must experience in order for indicator shaft 236 to expose indicia 108 on the outside of filter 100. A second factor to consider is whether there will be residual air pressure in chamber 244 (i.e., chamber 244 is not vented). In such a case, the pressure of the oil acting on partition 234 will need to overcome both the force exerted by biasing member 240 and the force exerted by the air pressure on the underside of partition 234 as it is compressed. If chamber 244 is not vented, the force exerted by biasing member 240 can be reduced. Alternatively, if chamber 244 is vented (e.g., where there is no indicator plug 238 and air can escape through aperture 218 or where indicator plug 238 includes a vent), then the pressure of the oil acting on partition 234 will need to overcome essentially only the force exerted by biasing member 240 on partition 234. In such a case, the strength of biasing member 240 should be increased. In the example shown in the view of FIG. 2, the chamber 44 is sealed by the seals 246 and 248, as described above.

The distance of compression x required of biasing member 240 will also determine the size of bypass aperture 232. When partition 234 is pressed downward, bypass aperture 232 become un-occluded such that oil bypasses filtering medium 206 by entering central filter cylinder 222 through bypass aperture 232. In other words, bypass aperture 232 relieves some of the oil pressure acting on partition 234. Therefore, for a particular strength of biasing member 240, the size of bypass aperture 232 is inversely proportional to the distance x that biasing member 240 must be compressed.

As discussed in part previously herein, a bypass device 254 is provided to reroute the oil flow around filter medium 206 during a clogged condition of filter medium 206. Bypass device 254 includes the partition 234 and the pressure seal 242 that prevent fluid from passing into the chamber 244. As pressure increases in the filter canister 206 partition 234 responds to the force, thus, causing partition 234 to move downward. When filter medium 206 is too clogged to permit proper oil passage, the pressure increases surpassing a predetermined force provided by the biasing member 240, subsequently forcing partition 234 down. Oil then travels around filter medium 206 and in through the bypass aperture 232 thereby transferring unfiltered oil back into machine 104 through the filter attachment aperture 212.

In this particular embodiment of the invention, oil flows from engine output ports 256 into the oil filter I 00 through the oil inlet ports 210. Under normal circumstances, such as when oil filter 100 is clean, oil flows smoothly through the ports 224 of the central filter cylinder 222 and then through the filtering medium 206 as indicated by arrows 258. Clean oil flows out of the oil filter 100 through the filter attachment aperture 212 and then through an engine inlet port 260.

A soft rubber gasket 262 creates a seal between the filter attachment aperture 212 and the central filter cylinder 222. Further, the gasket 262 has a flexible lip 264 that allows oil to easily flow through inlet ports 210 but tends to prevent unfiltered oil from flowing back into machine 104 when it is not running. In the view of FIG. 2 fluid (oil) 266 is shown flowing through the oil filter 100 and so the flexible lip 264 is shown deflected somewhat away from the first housing section 204. However, were the oil 266 not flowing, the flexible lip 264 of the gasket 262 would seal the oil inlet ports 210 so that the oil 266 could not flow there through back out of the oil filter 100. This feature is particularly useful when changing the oil filter 100, as it helps to prevent the mess that would be caused by a great deal of oil 266 leaking out of the oil filter 100 after it is removed from the machine 104. In this particular embodiment, filter 100 is mounted right side up on the bottom of machine 104. However, it is not uncommon for this type of oil filter to be mounted in different positions, even upside down as compared to the example of FIGS. 1A and 1B. If the oil filter 100 were to be so mounted, the weight of the oil 266 retained within disposable oil filter 100 would push against the flexible lip 264 thereby causing the lip 264 to block off the inlet ports 210, as discussed above. This would further prevent unfiltered oil 266 from flowing back into the machine 104.

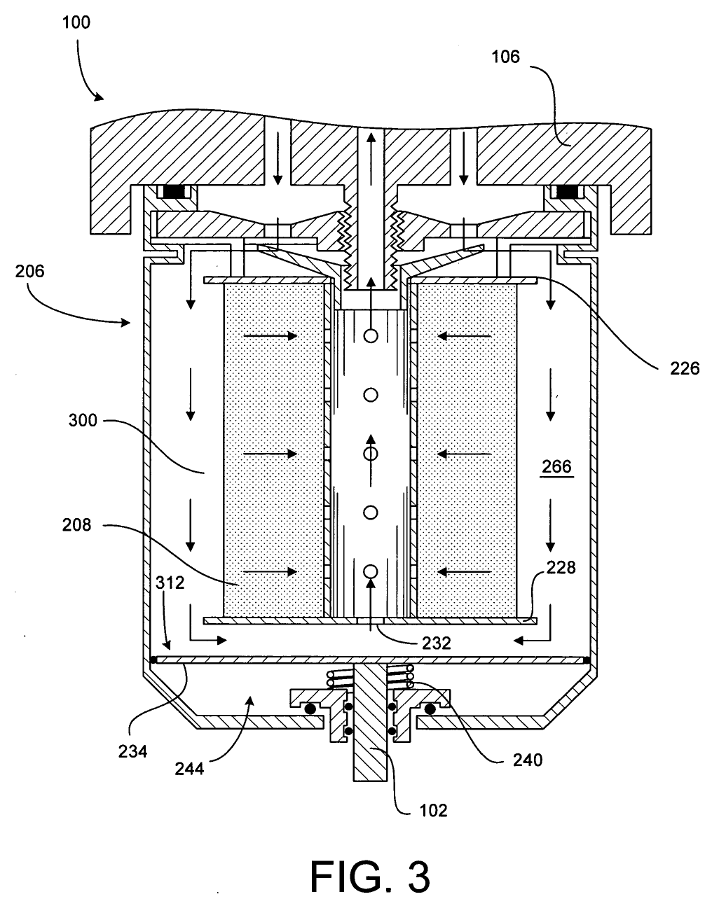

FIG. 3 is a cross-sectional view of fluid filter 100 of FIG. 1 taken along lines A-A, similar to the view of FIG. 2. The view of FIG. 3 represents the condition of the filter 100 in a generally clogged state such that the indicator 102 is protruding, thereby signaling that it is time to replace disposable oil filter 100. In this particular embodiment, the filter 208 medium is clogged and no longer permeable to oil 266. An oil pump (not shown) within machine 104 continues to pump oil 266 into the oil filter 100, thus, increasing the pressure within a fluid portion 300 of the canister 206. Pressure reaches a point wherein the opposite force provided by biasing member 240 can no longer prevent the partition 234 from being forced downward. Partition 234 then moves downward permitting unfiltered oil 266 to move around clogged filter medium 208 and out through bypass aperture 232, were it is transferred back to machine 104. Bypass aperture 232 is substantially small such that partition 234 will require a greater distance of travel in response to an increased absolute pressure. A greater distance of travel will enable a user to more easily see the pressure indicator 102 and, thereby, the condition of fluid filter 100. It should be noted that the condition depicted in the view of FIG. 3 is achieved when the internal absolute pressure is greater than that of the opposite pressure applied by biasing member 240.

As can be seen by comparing the views of FIGS. 2 and 3, in FIG. 2 the partition 234, and parts attached thereto, are in a first (non-actuated) position 310, while in FIG. 3 the partition 234, and parts attached thereto, are in a second (actuated) position 312. Optionally, a locking mechanism (not shown) can be provided to prevent partition 234 from moving from the second (actuated) position back into the first (non-actuated position) once activated.

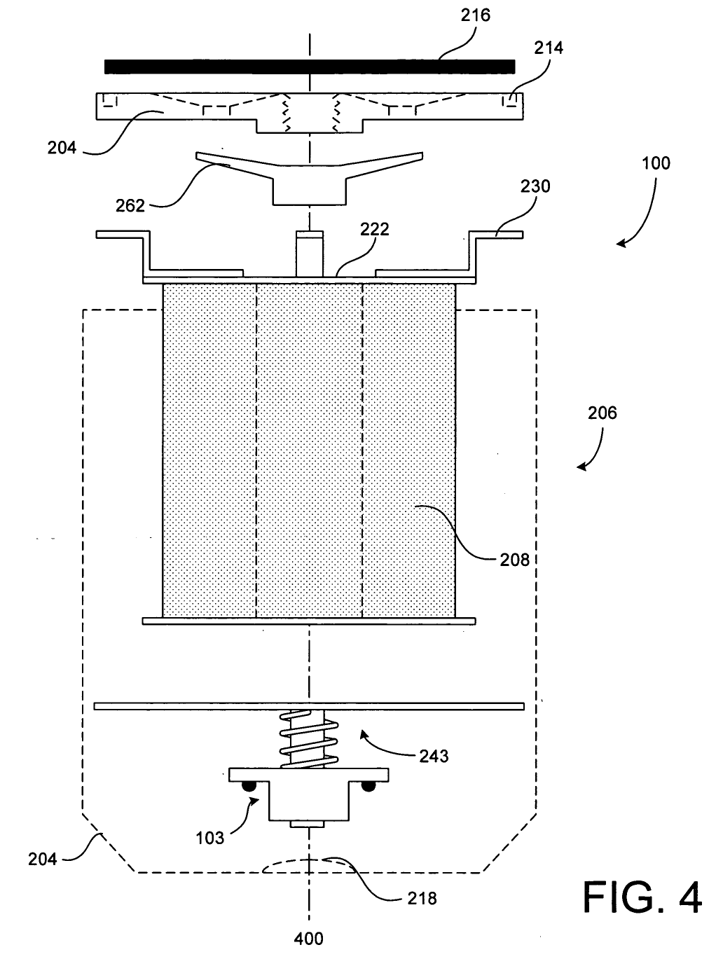

FIG. 4 is an exploded view of the internal parts of fluid filter 100 showing the order of assembly. An assembly combining the bypass apparatus 208 and the pressure indicating apparatus 103 is first placed into the filter canister 206. As previously discussed herein, the pressure indicating apparatus 103 is inserted into the indicator aperture 218 in the second housing section 204 of the filter canister 206.

Next, the filter medium 208, with the support members 230 attached, are placed to align filter medium 208 with a vertical axis 400. In this particular embodiment, support members 230 are eventually crimped between first housing section 202 and second housing section 204 whereby filter medium 208 is locked into position upon assembly. Rubber gasket 262 is then placed into end of the central filter cylinder 222. After the above described internal parts are aligned within the second housing section 204, the upper housing section 202 is permanently sealed onto the lower housing section 204 such that it cannot not be reopened without destroying the device. Finally, O-ring 216 is placed within the O-ring seat 214.

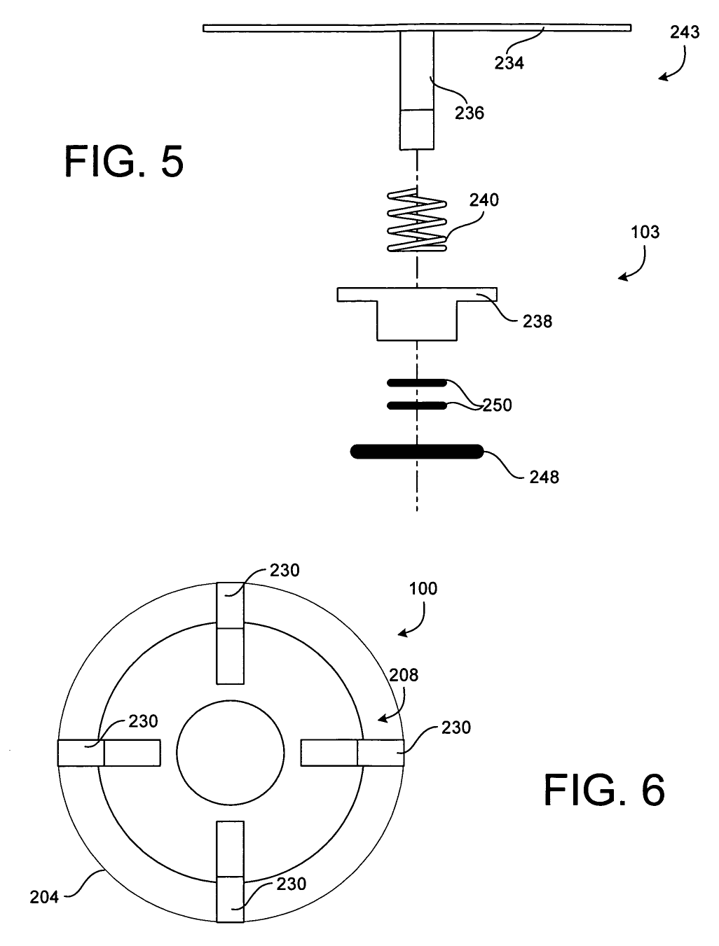

FIG. 5 is an exploded view of bypass apparatus 243 and pressure indicator apparatus 103 of fluid filter 100. To assemble the apparatus depicted in FIG. 5, seal 154 is placed around the central portion of indicator plug 238. O-ring seals 250 are inserted into channels (not visible in the view of FIG. 5) defined within plug aperture 239. Shaft 236 is placed through biasing member 240 and then through O-ring seals 250 already seated within indicator plug 238.

FIG. 6 is a top view of filter medium 208 within fluid filter 100 of FIG. 1. In this particular embodiment, four support members 230 keep filter medium 208 centered within the second housing portion 204. Further, support members 230 secure the filter medium 208 into a fixed position within fluid filter 100.

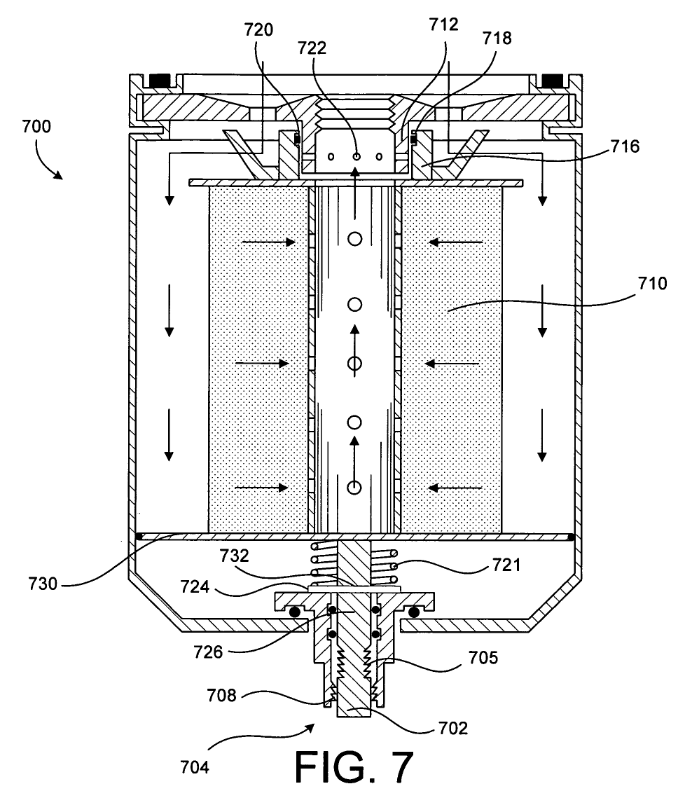

FIG. 7 shows a cross-sectional view of an alternate fluid filter 700. In this particular embodiment, fluid filter 700 includes an indicator 702 which further includes a locking member 704 (a retainer). Upon actuation from a dirty filter, indicator 702 is locked into position so that it can be read when the engine is not running. Locking member 704 includes ramped teeth 705 that lock indicator 702 into complementary teeth 708 upon actuation. Ramped teeth 705 and 708 are angled such that indicator 702 can move outward and not inward.

Alternate fluid filter 700 includes a movable filter 710 that moves down outlet port 712 upon actuation. Movable filter 710 includes a top portion 716 that closely engages outlet port 712. Top portion 716 defines an inner channel 718 that seats a seal 720 similar to O-ring 216 of fluid filter 100. When the absolute pressure exceeds a predetermined force of a spring 721, movable filter 710 responds to the force by sliding down outlet port 712. Seal 720 slides past bypass ports 722 of outlet port 712, thus, exposing bypass ports 722 to unfiltered oil. Unfiltered oil then bypasses clogged movable filter 710 and is directed back into the engine.

A surge protecting washer 724 prevents indicator 702 from providing a false indication. When oil is cold, it has a higher viscosity than when it is warm and movable filter medium 710 is more resistant to thick oil. Therefore, when clean oil is cold and thick, it flows through alternate fluid filter 700 like dirty oil. In this particular embodiment, surge protecting washer 724 tightly engages an indicator shaft 726 such that under low temperatures, indicator 702 cannot actuate.

When temperatures increase within alternate fluid filter 700, heat transfers through a partition 730 and indicator shaft 726. Heat then reaches surge protecting washer 724, causing it to increase in size due to thermal expansion. An aperture 732 of surge protecting washer 724 expands substantial to disengage indicator shaft 726. Alternate fluid filter 700 is then able to actuate into a bypass stage. The diameter of surge protecting washer 724 is slightly larger than that of spring 721 such that it can be secured into position by spring 721.

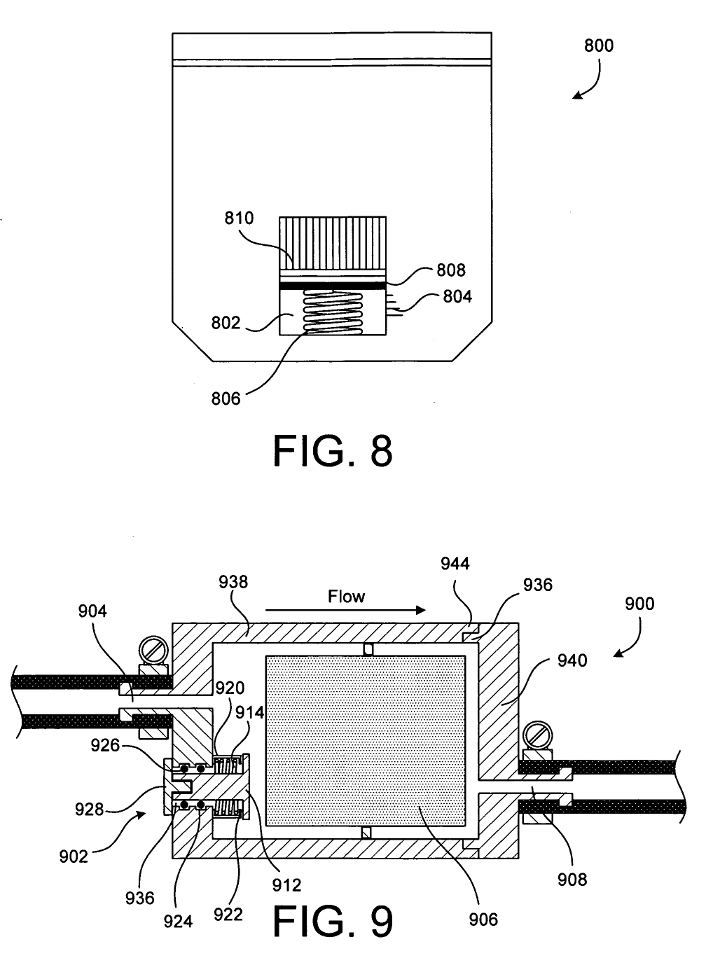

FIG. 8 shows a front view of an alternate fluid filter 800 including means for indicating when fluid filter 800 is no longer filtering oil efficiently. Fluid filter 800 includes a transparent window 802, which enables a user to easily see when disposable oil filter 800 is no longer permitting proper oil flow. In this particular embodiment, hatch marks 804 next to window 802 indicate how dirty a filter medium 810 is. As the filter becomes increasingly clogged, a partition 808 gradually overcomes the force exerted by a spring 806 and moves relative to hatch marks 804 into a bypass position. The dirtier filter medium 810 becomes, the further down hatches 804 partition 808 will move in response to an increased absolute pressure.

FIG. 9 shows a cross-sectional view of an in-line fluid filter 900 including an absolute pressure indicator 902. Absolute pressure indicator 902 includes a pressure surface 912 that is forced outward by a spring 914. A rubber boot 920 surrounds spring 914 such that fluid cannot reach an under portion 922, of pressure surface 912. In-line fluid filter 900 further includes channels 924 to seat seals 926. Further, seals 926 protect the inner portion of in-line fluid filter 900 from foreign matter and prevent fluid from escaping. A visible portion 928 of absolute pressure indicator 902 is slightly larger than an aperture 936 such that the force from spring 914 cannot push indicator 902 into in-line fluid filter 900.

In-line oil filter 900 includes two housing portions 938 and 940 fixed together to enclose filter medium 906. In this particular embodiment, filter medium 906 is fixed within housing portion 938. Housing portion 938 further includes a portion 944 that is permanently affixed to complementary portion 946 of housing portion 940.

In-line fluid filter 900 works according to essentially the same principles as previously described embodiments of the invention. When a filter medium 906 is clean, unfiltered fluid enters in-line fluid filter 900 through an inlet port 904. Then, unfiltered fluid flows smoothly through a filter medium 906. Filtered fluid then exits in-line fluid filter 900 through an outlet port 908. In this particular embodiment, in-line fluid filter 900 does not include a bypass system.

In the case of a clogging condition, fluid enters in-line fluid filter 900 through inlet port 904. Because filter medium 906 is clogged and no longer permeable to fluid, there is an absolute fluid pressure increase. When this absolute pressure increases beyond the predetermined force of spring 914, pressure surface 912 is forced into an actuated position that is visible outside of in-line fluid filter 900. This indicates that filter medium 906 is no longer permitting proper oil flow and needs to be changed. This provides a much needed indicator for in-line filters such as fuel filters, where there is no indication of blockage other than poor performance or complete engine failure due to fuel blockage.

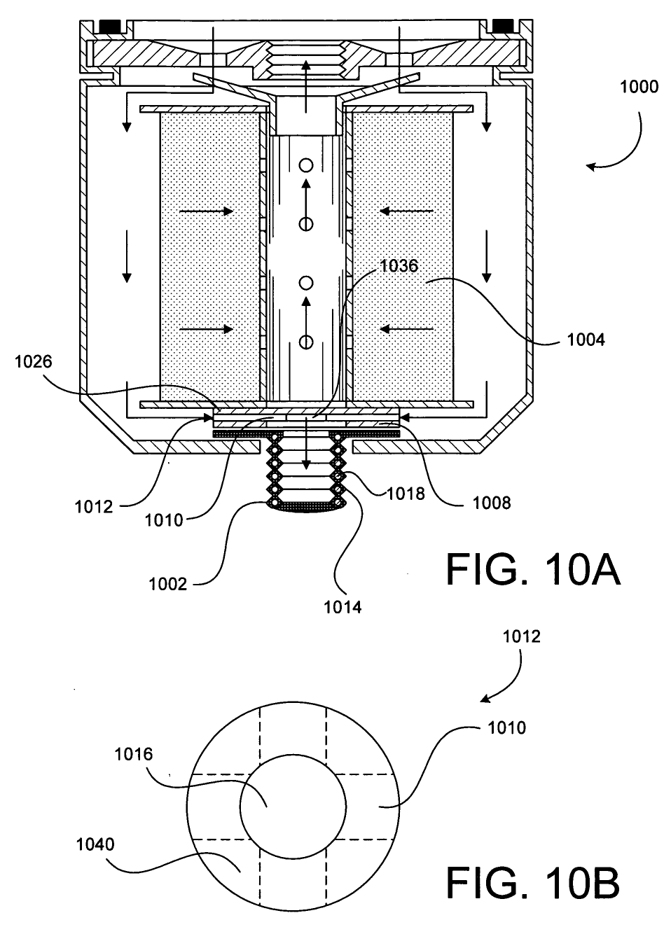

FIG. 10A is a cross-sectional view of an alternate fluid filter 1000 including an alternate indicator 1002. In this embodiment, indicator 1002 forms an expandable chamber that expands when the absolute pressure within alternate fluid filter 1000 increases due to a clogged filter medium 1004. Oil transfers through channels 1010 of a channeled washer 1012 and into a bellowed expandable portion 1014 of indicator 1002. When the absolute pressure exceeds a predetermined force of a spring 1018 within expandable portion 1014, indicator 1002 expands and protrudes outward such that a user can easily see that alternate fluid filter 1000 is ready to be changed.

In this particular embodiment, a solid disk-shaped plate 1026 prevents fluid from transferring back into the engine without passing through filter medium 1004. Under solid disk 1026 is the channeled washer 1012, of the same diameter, that includes channels 1010 and a central aperture 1036. Channels 1010 define paths for fluid to flow to aperture 1036. Aperture 1036 permits fluid to flow to expandable portion 1014 of indicator 1002. In this particular embodiment, there is no bypass device or similar system.

FIG. 10B shows a top view of channeled washer 1012 including four channels 1010. Channeled washer 1012 further includes four pie-shaped sections 1040 that support solid disk-shaped plate 1006 (FIG. 10A). Furthermore, channeled washer 1012 includes aperture 1036 that permits fluid to flow from channels 1010 into indicator 1002.

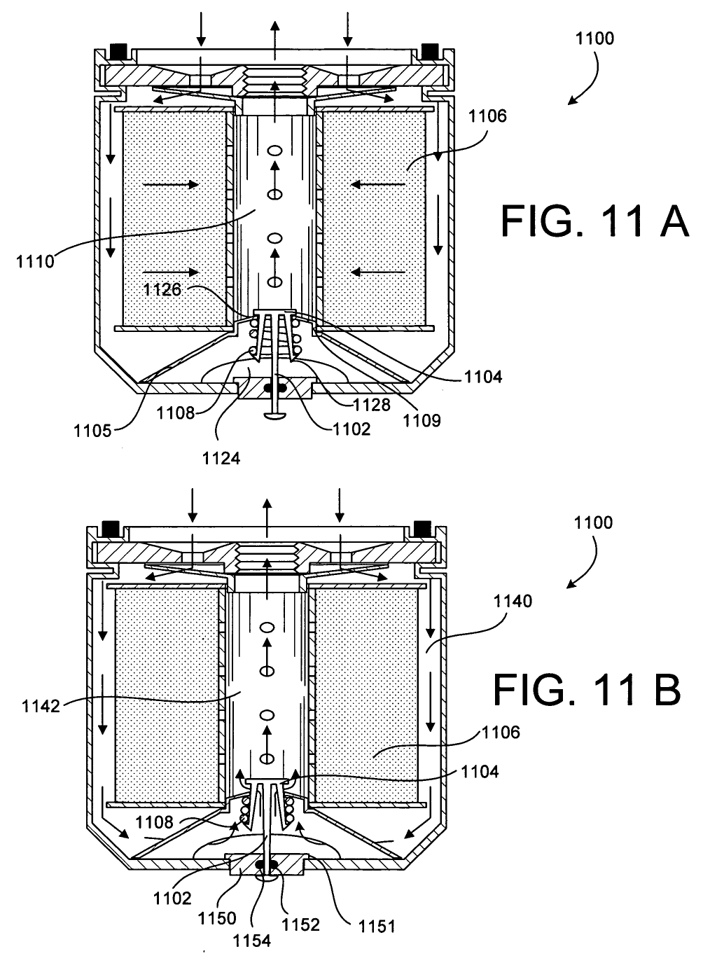

FIG. 11A is a cross-sectional view of a clean modified Fram™ brand Extra Guard™ oil filter 1100, model number PH3614. A visible indicator 1102 is coupled to a bypass valve 1104 that is activated by a differential pressure, as opposed to previously described bypass valves that are activated by absolute pressure.

A filter support 1105 provides a base for a filter medium 1106 and a surface for abutting a spring 1108. Filter support 1105 further has a raised portion 1109 that engages an inner portion 1110 of filter medium 1106. Furthermore, filter support 1105 defines an opening 1124 for oil to reach bypass valve 1104 and another opening 1126 wherein bypass valve 1104 is disposed. Bypass valve 1104 includes hooked arms 1128 that engage spring 1108. In this particular embodiment, indicator 1102 protrudes outward to signal a clean filter.

FIG. 11B shows a cross-sectional view of a clogged modified Fram™ brand Extra Guard™ oil filter 1100, model number PH3614. In this example of the embodiment, filter medium 1106 is dirty and no longer permeable to oil. Fluid pressure increases on an outer portion 1140 of FRAM oil filter 1100 while the fluid pressure of an inner portion 1142 remains consistent, thereby increasing the pressure differential across filter medium 1106. When the pressure differential exceeds the counter force of spring 1108, bypass valve 1104 is forced into an open position. Accordingly, indicator 1102 is pulled in, signaling to a user that it is time to change the filter 1100.

Modified oil filter 1100 further includes a plug 1150 that supports indicator 1102. Plug 1150 has a lip 1151 that prevents plug 1150 from being forced out of modified oil filter 1100 by oil pressure. In this particular embodiment, a seal 1152 is seated within a channel 1154 of plug 1150 to prevent oil from leaking out of filter 1100. Seal 1152 is sufficiently snug so as to keep oil in, yet loose enough to permit movement of indicator 1102.

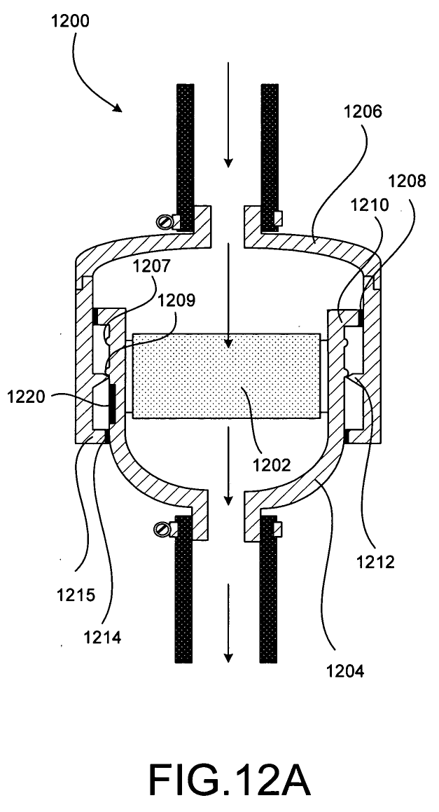

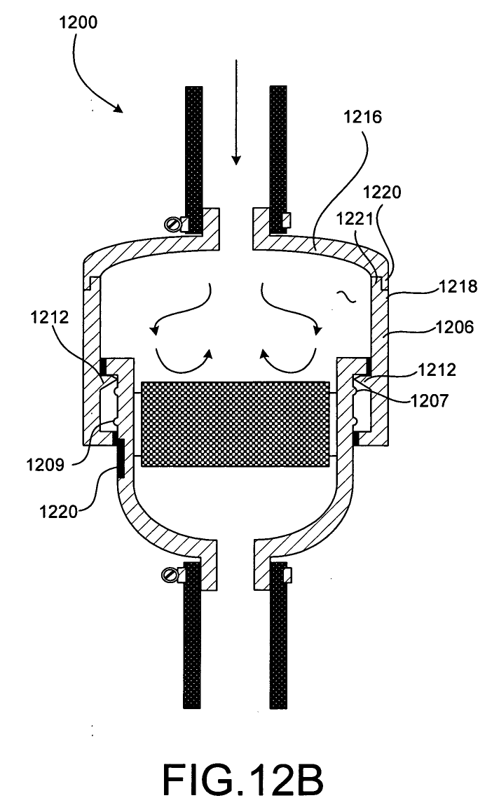

FIG. 12A shows a cross-sectional view of an alternate in-line fluid filter 1200 that includes means for indicating when a filter medium 1202 is clogged. In-line fluid filter 1200 includes two housing portions 1204 and 1206. Inner housing portion 1204 is movably coupled within outer housing 1206. Inner housing 1204 includes a gasket 1208 affixed to a lip 1210 that catches a ramp 1212 of outer portion 1206 upon actuation so that inner housing portion 1204 cannot pop completely out of the outer portion 1206. Inner housing portion 1204 further includes two small protrusions 1207 and 1209, which ramp 1212 snaps over during actuation. Alternate inline fluid filter 1200 further includes another gasket 1214 affixed to another lip 1215 that encloses protrusions 1207, 1209 and ramp 1212 such that outside elements cannot interfere with the actuation of alternate inline oil filter 1200.

FIG. 12B shows a cross-sectional view of alternate in-line fluid filter 1200 that includes a clogged filter medium 1202. In this particular embodiment, absolute pressure increases sufficient to force ramp 1212 over first protrusion 1209 and then over second protrusion 1207 which locks in-line oil filter 1200 into an actuated position. There is a distance between protrusion 1209 and protrusion 1207 such that a user can easily see that in-line fluid filter 1200 is “popped out” and ready to be changed.

Housing portion 1206 includes a top portion 1216 fixed to a bottom portion 1218. Once inner components are positioned during assembly, top portion 1216 is permanently attached to bottom portion 1218 (as by welding, gluing, or the like—in this instance the attachment is by glue). It should be noted that the inner housing portion 1204 is optionally provided with an indicia 1220 that is occluded by the outer housing portion 1206 in normal operating conditions. Only when excessive fluid pressure has caused the alternate in-line fluid filter to expand is the indicia 1220 visible to a user.

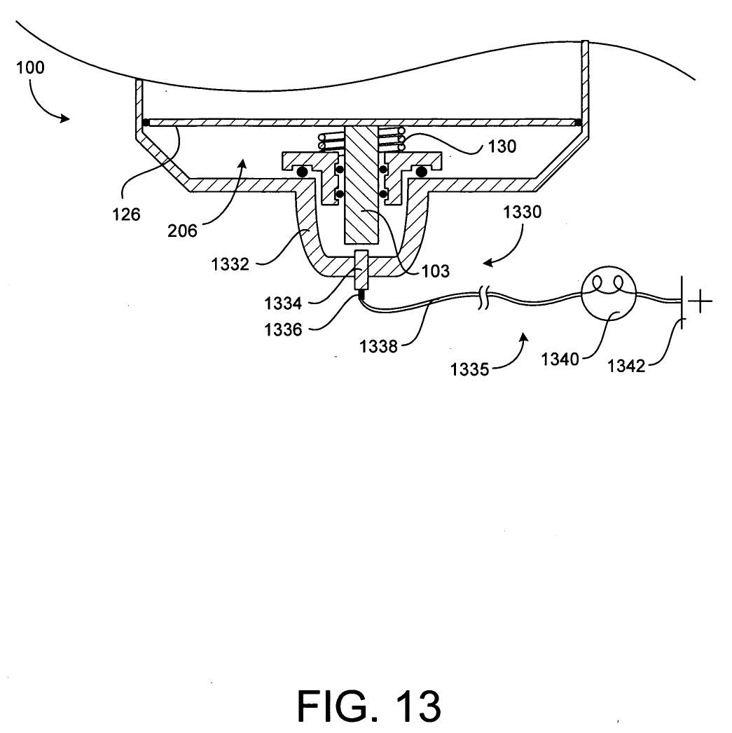

FIG. 13 is a diagrammatic cross sectional view, similar to the views of FIGS. 2 and 3, of an alternate pressure indicator apparatus 1330 that, in large part, is similar to the pressure indicator apparatus 103 previously described here. The pressure indicator apparatus 1330 differs from the apparatus 103 in that a non-conductive support member 1332 provides support for an electrical contact 1334. The electrical contact 1334 has a connector 1136 for connecting the electrical contact 1334 to a wire 1338. The wire 1338 can be connected to any number of electrical indicating devices, such as a buzzer, or the like. In the present example, the indicator device 1340 is a light bulb that is also connected to an electrical current source 1342.

In the example of FIG. 13, since the alternate pressure indicator apparatus 1330 will be grounded, through the mechanical connections described in relation to the previous embodiments of the invention, to the apparatus (not shown) for which it is intended, when the indicator 103 (a metal shaft) protrudes sufficiently that it comes into contact with the electrical contact 1334 a circuit 1335 will be made from the current source 1342, through the indicating device 1340, through the electrical contact 1334 and through the indicator 102 to ground, thereby actuating the indicator device 1340 (that is, lighting the light bulb, in this example) to alert a user to the fact that the filter 100 is clogged. Alternatively, if perhaps the filter 100 is not grounded, then one skilled in the art will recognize that a ground wire could readily be attached to the alternate pressure indicator apparatus 1330.

The alternative pressure indicator apparatus described in relation to FIG. 13 is intended for applications where the filter 100 is not readily visible to an operator. The indicator device 1340 can be placed in a convenient location such that it may readily be monitored. The modification represented by the alternate indicator apparatus 1330 could easily be modified to work with any of the embodiments of the invention described herein, or any other embodiments of the invention now in existence or yet to be devised.

The above description of some particular embodiments is but an example of the many forms that the present invention may take. Many of the described features may be substituted, altered or omitted without departing from the scope of the invention. For example, alternate methods for coupling housing portions (such as, screwing, heat welding, epoxy, and the like), may be substituted for gluing. As another example, alternate biasing members such as flexed steal tabs may be substituted for a spring biasing member. These and other deviations from the particular embodiments shown will be apparent to those skilled in the art, particularly in view of the foregoing disclosure.

I claim:

1. A fluid filter comprising:
a filter canister;
a filter medium disposed within said filter canister; and
an indicator apparatus permanently affixed to, and at least partially within, said filter canister;
said indicator apparatus being responsive to a predetermined fluid pressure within said filter canister.

2. A fluid filter according to claim 1, wherein:
said fluid filter is a self contained unit that can be removed from a machine as a unit and replaced with another fluid filter.

3. A fluid filter according to claim 1, wherein:
said indicator apparatus includes a visual indicator which can be seen from outside said filter canister.

4. A fluid filter according to claim 3, wherein:
said indicator is visible through said canister.

5. A fluid filter according to claim 1, wherein:
said indicator includes an electrical contact that completes an electrical circuit at the predetermined fluid pressure.

6. A fluid filter according to claim 1, wherein:
the filter canister includes a first housing section and a second housing section.

7. A fluid filter according to claim 6, wherein:
said first housing section is adapted to be coupled to a source of fluid; and
said second housing section includes a window through which said indicator is visible.

8. A fluid filter according to claim 6, and further including:
at least one indicator mark on said second housing section whereby alignment of said indicator and said indicator mark is indicative of said predetermined pressure.

9. A fluid filter according to claim 1, wherein:
said indicator apparatus passes at least partially through said filter canister.

10. A fluid filter according to claim 6, wherein:
said first housing section is adapted to be coupled to a source of fluid; and
said indicator passes at least partially through said second housing section.

11. A fluid filter according to claim 1, and further comprising:
a partition movably disposed within said filter canister; wherein
fluid pressure within said filter canister acts on said partition to cause said partition to move; and
said indicator is coupled to said partition.

12. A fluid filter according to claim 11, and further comprising:
a biasing member disposed to urge said partition toward a first position; wherein
fluid pressure acting on said partition pushes said partition toward a second position away from said first position.

13. A fluid filter according to claim 11, and further comprising:
a bypass aperture facilitating the flow of at least a portion of fluid through said fluid filter without flowing through said filter medium; wherein
said partition occludes said bypass aperture until the fluid pressure reaches said predetermined pressure.

14. A fluid filter according to claim 11, wherein:
said filter medium is slidably disposed within said filter canister; and
said partition is coupled to said filter medium.

15. A fluid filter according to claim 11, and further comprising:
at least one seal disposed between said indicator and said filter canister to prevent fluid from leaking out of said filter canister where said indicator passes through said filter canister.

16. A fluid filter according to claim 15, wherein:
said indicator is disposed through an aperture in said filter canister;
said seal is an indicator plug positioned in said aperture; and
a portion of said indicator passes through said aperture.

17. A fluid filter according to claim 1, wherein said indicator comprises:
a pressure member having a first surface and a second surface, said first surface having force exerted thereon by fluid pressure;
a shaft coupled to said pressure member and passing through a wall of said filter canister; and
a seal for preventing fluid pressure from exerting force on said second surface.

18. A fluid filter according to claim 17, wherein said indicator apparatus further comprises:
a spring disposed between said second surface of said pressure member and said filter canister; and
said seal includes a flexible boot surrounding said spring and said second surface of said pressure member.

19. A fluid filter according to claim 1, wherein:
said indicator apparatus includes an expandable chamber passing through said filter canister;
the volume of said expandable chamber being variable according to the pressure of a fluid; and
said expandable chamber has a predetermined volume wherein the pressure of said fluid is equal to said predetermined pressure.

20. A fluid filter according to claim 19, wherein said expandable chamber includes:
a spring; and
a flexible wall surrounding said spring and affixed to both said spring and to said filter canister.

21. A fluid filter according to claim 19, and further including:
a spacer disposed between said filter canister and said filter medium, said spacer facilitating entry of said fluid into said expandable chamber and preventing said fluid from bypassing said filter medium.

22. A fluid filter according to claim 1, wherein:
said filter canister includes an aperture facilitating the flow of fluid there through;
said indicator apparatus includes an expandable chamber affixed to the outside of said filter canister about said aperture such that fluid can flow into said expandable chamber through said aperture;
the volume of said expandable chamber increases as fluid pressure increases; and
said expandable chamber has a predetermined volume when the fluid pressure in the filter canister is equal to said predetermined pressure.

23. A fluid filter according to claim 1, wherein:
said filter medium is slidably disposed within said filter canister.

24. A fluid filter according to claim 23, wherein:
said filter medium is coupled to said indicator apparatus.

25. A fluid filter according to claim 24, wherein:
said indicator is visible through said canister.

26. A fluid filter according to claim 1, wherein:
said filter medium is fixed within said filter canister.

27. A fluid filter according to claim 26, and further comprising:
at lest one support member maintaining said filter medium in a fixed position.

28. A fluid filter according to claim 1, wherein:
said indicator apparatus is responsive to fluid pressure on one side of said filter medium without regard to fluid pressure on an opposite side of said filter medium.

29. A fluid filter according to claim 1, and further comprising:
a retainer, and wherein
said indicator apparatus is operative to move from a first position to a second position; and
the retainer is operative to maintain said indicator in said second position.

30. A fluid filter according to claim 29, wherein:
said retainer includes at least one protrusion operative to engage said indicator apparatus and to maintain said indicator apparatus in said second position.

31. A fluid filter according to claim 29, wherein:
said retainer includes a plurality of teeth;
said indicator apparatus includes a plurality of complementary teeth; and
when said indicator apparatus moves to said second position then said teeth of said retainer engage said complementary teeth of said indicator apparatus to maintain said indicator apparatus in said second position.

32. A fluid filter according to claim 1, and further comprising:
a surge suppressor; and wherein
said indicator apparatus is operative to move in response to fluid pressure; and
said surge suppressor is operative to prevent said indicator apparatus from moving when said surge suppressor is cold.

33. A fluid filter according to claim 32, wherein:
said indicator apparatus includes a shaft; and
said surge suppressor includes a thermally expandable washer disposed around said shaft.

34. A fluid filter according to claim 1, and further comprising:
an inlet port;
an outlet port; and
a bypass valve for facilitating the flow of fluid from said inlet port to said outlet port without passing through the filter medium; and wherein
said indicator apparatus is coupled to said bypass valve such that said indicator apparatus and said bypass valve move generally in unison.

35. A fluid filter according to claim 6, wherein:
said first housing section is slidably coupled to said second housing section such that said filter canister is operative to expand responsive to fluid pressure therein.

36. A fluid filter according to claim 35, wherein:
said first housing section includes at least one engaging feature on an exterior surface thereof;
said second housing section slidably engages said first housing section and further includes at least one complementary engaging feature on a interior surface thereof;
wherein
said engaging feature engages said complementary engaging feature; and
in at least some conditions, fluid pressure within said fluid filter is operative to cause said engaging feature to disengage from said complementary engaging feature.

37. A fluid filter according to claim 36, wherein:
said first housing section includes an indicia on an outer surface thereof, said indicia being occluded by said second housing section when said engaging feature is engaged with said complementary engaging feature.

38. A method for manufacturing a disposable canister filter, said method comprising:
providing a filter medium;
providing a fluid pressure indicator;
providing a canister; and
assembling said filter medium, said fluid pressure indicator and said canister into a unitary disposable canister filter.

39. A method according to claim 38, wherein:
said step of assembling said disposable canister filter includes installing said fluid pressure indicator such that a portion of said fluid pressure indicator is visible from the outside of said disposable filter canister.

40. A method according to claim 38, wherein:
said step of assembling said disposable canister filter includes installing said fluid pressure indicator such that the visible portion of said fluid pressure indicator moves in response to a change in the pressure of a fluid within said disposable canister filter.

41. A method according to claim 38, wherein said step of assembling said disposable canister filter includes installing said filter medium such that said filter medium is slidably disposed within said canister.

42. A method according to claim 38, wherein:
said step of assembling said disposable canister filter further includes installing a retainer operative to retain said indicator in a predetermined position when the pressure of fluid in said disposable canister filter reaches a predetermined pressure indicative of said filter medium becoming clogged.

43. A method according to claim 38, wherein:
said step of assembling said disposable canister filter includes installing a surge suppressor operative to retain said indicator in a predetermined position until a fluid in said disposable canister filter has reached a predetermined temperature.

44. A disposable fluid filter comprising:
a enclosed canister;
a filter medium disposed within said canister; and
means, affixed to said enclosed canister and removable therewith, for indicating an increased fluid pressure resulting from said filter medium becoming clogged.
